(19) United States
(12) Patent Application Publication
(10) Pub. No.: US 2011/0222951 A1
(43) Pub. Date: Sep. 15, 2011

(54) ERASING DEVICE, IMAGE FORMING APPARATUS, SHEET CASSETTE COMMON USE SYSTEM, AND A STORING METHOD OF ERASE-PROCESSED SHEETS

(75) Inventors: Isao Yahata, Shizuoka-ken (JP); Ken Iguchi, Shizuoka-ken (JP); Takahiro Kawaguchi, Shizuoka-ken (JP); Hiroyuki Taguchi, Shizuoka-ken (JP); Hiroyuki Tsuchihashi, Shizuoka-ken (JP); Hiroyuki Taki, Shizuoka-ken (JP)

(73) Assignee: Kabushiki Kaisha Toshiba, Tokyo (JP)

(21) Appl. No.: 13/042,909

(22) Filed: Mar. 8, 2011

Related U.S. Application Data
(60) Provisional application No. 61/312,072, filed on Mar. 9, 2010.

(51) Int. Cl. B41J 13/10

(52) U.S. Cl. 400/645.2

(57) ABSTRACT

An erasing device includes an image erasing portion that erases an erasable image which is printed on a sheet using an erasable color material, a reusability determination portion that determines whether or not to reuse the sheet obtained by erasing the erasable image by the image erasing portion; a sorting carrying portion that carries the determined sheets to a carrying destination for reusable sheets and a carrying destination for non-reusable sheets according to the determination result from the reusability determination portion; a common sheet cassette that can be used in an image forming apparatus and detachably installed in the carrying destination for reusable sheets, and that stacks and contains the sheets from the sorting carrying portion therein; a storage medium that is installed in the common sheet cassette; and a communication portion that stores information regarding the sheets contained in the common sheet cassette in the storage medium.

### CROSS-REFERENCE TO RELATED APPLICATION

This application is based upon and claims the benefit of priority from: U.S. provisional application, 61/312,072, filed on Mar. 9, 2010; the entire contents of each of which are incorporated herein by reference.

### FIELD

Embodiments described herein relate generally to a technique regarding a cassette which stacks erased sheets obtained by erasing an erasable image by an erasing device.

### BACKGROUND

There is provided an erasing device which erases an erasable image printed on a sheet, for example, by heating, and the sheet is reused. In order to stack the erased sheets obtained by erasing an erasable image in plurality inside the erasing device and reuse the plurality of erased sheets, if a device for stacking sheets can be directly installed in an image forming apparatus such as a printer in the form of a paper feeding cassette, the use of the erased sheets can be promoted.

In addition, if sheets stacked in the paper feeding cassette installed in the image forming apparatus such as a printer are discriminated as new sheets or the erased sheets, active use of erased sheets can be promoted.

### DESCRIPTION OF THE DRAWINGS

FIG. 1 is a schematic longitudinal cross-sectional view illustrating an erasing device according to a first embodiment.

FIG. 2 is a diagram illustrating a structure and a control block of a reusability determination portion provided in the erasing device in FIG. 1.

FIG. 3 is a flowchart illustrating an operation in the control block in FIG. 2.

FIG. 4 is a schematic longitudinal cross-sectional view illustrating an image forming apparatus according to an embodiment.

FIG. 5 is a perspective view of a sheet cassette used in the erasing device in FIG. 1 and the erasing device in FIG. 4.

FIG. 6 is a schematic diagram illustrating a sensor which detects movement directions of the limitation member and the adjuster provided in the sheet cassette in FIG. 5 and a sheet size.

FIG. 7 is a block diagram illustrating communication between the sheet cassette in FIG. 6 and the image forming apparatus.

FIG. 8 is an exploded perspective view illustrating a sheet cassette according to a second embodiment.

FIG. 9 is a schematic longitudinal cross-sectional view illustrating a sheet cassette according to a third embodiment.

### DETAILED DESCRIPTION

According to one embodiment, there is provided an erasing device including an image erasing portion that erases an erasable image which is printed on a sheet using an erasable color material; a reusability determination portion that determines whether or not to reuse the sheet obtained by erasing the erasable image by the image erasing portion; a sorting carrying portion that carries the determined sheets to a carrying destination for reusable sheets and a carrying destination for non-reusable sheets according to the determination result from the reusability determination portion; a common sheet cassette that can be used in an image forming apparatus and detachably installed in the carrying destination for reusable sheets, and that stacks and contains the sheets from the sorting carrying portion therein; a storage medium that is installed in the common sheet cassette; and a communication portion that stores information regarding the sheets contained in the common sheet cassette in the storage medium.

According to one embodiment, there is provided an image forming apparatus including an image forming portion that forms an image on a sheet using a color material based on image information; a sheet cassette installation portion where a sheet cassette which feeds the sheet to the image forming portion is installed; a common cassette that contains therein a erased sheet obtained by erasing an erasable image by an erasing device, stores information regarding contained sheets in a storage medium, and can be commonly used with the erasing device; a communication portion that extracts information stored in the storage medium through communication with the storage medium; a display portion that displays the information regarding sheets extracted via the communication portion; and a control unit that controls the communication portion and the display portion.

According to one embodiment, there is provided a sheet cassette common use system including an erasing device that has a sheet cassette which contains therein a erased sheet obtained by erasing an erasable image and a storage medium which stores information regarding contained sheets and is provided in the sheet cassette; an image forming apparatus that can be installed with the sheet cassette provided with the storage medium as a commonly used cassette and forms an image on a sheet which is fed from the common cassette, using a color material based on image information; and an information communication portion that is provided in both of the erasing device and the image forming apparatus and exchanges sheet information regarding contained sheets via the storage medium of the common cassette.

According to one embodiment, there is provided a sorting method of erase-processed sheets comprising determining by a reusability determination portion whether or not to reuse the sheet obtained by erasing the erasable image which is printed on a sheet using an erasable color material by the image erasing portion; carrying the determined sheets by a sorting carrying portion to a carrying destination for reusable sheets and a carrying destination for non-reusable sheets according to the determination result from the reusability determination portion; stacking and containing the sheets from the sorting carrying portion on a common sheet cassette that install a storage medium and that can be used in an image forming apparatus and can be detachably installed in the carrying destination for reusable sheets; and storing information regarding the sheets contained in the common sheet cassette in the storage medium by a communication portion.

Hereinafter, an image forming apparatus related to this embodiment will be described in detail with reference to the accompanying drawings.

### First Embodiment

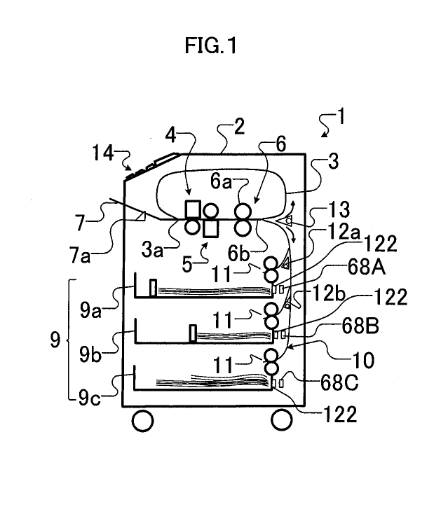

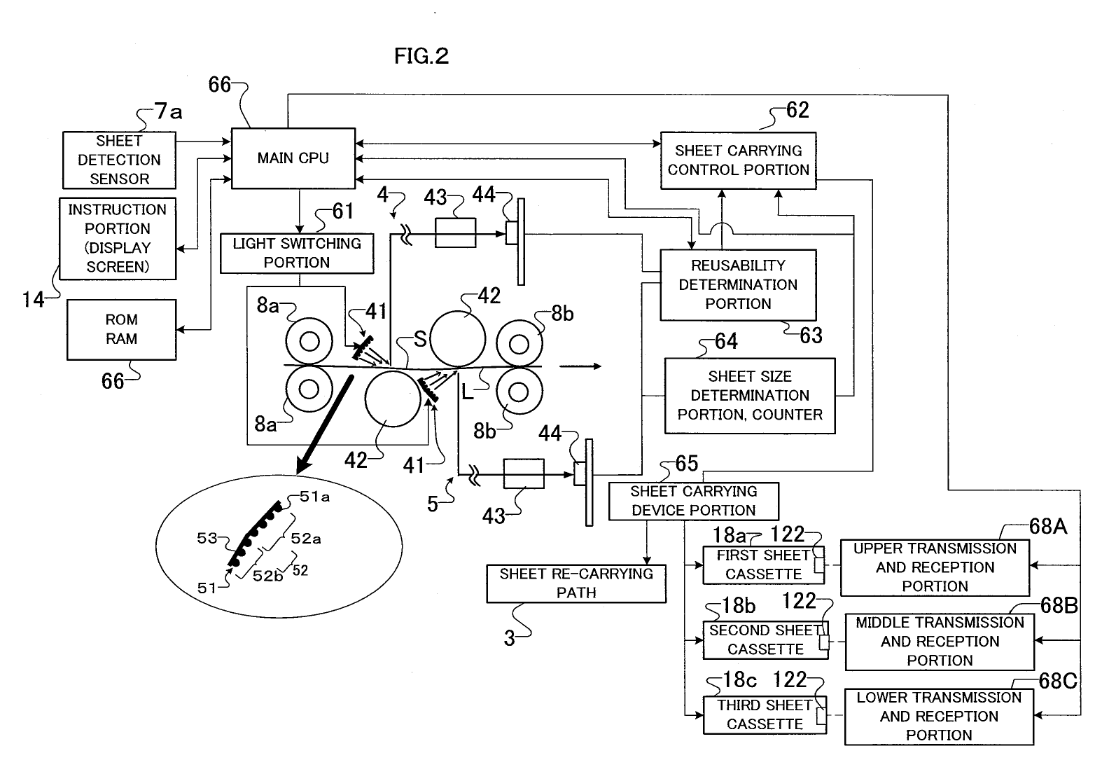

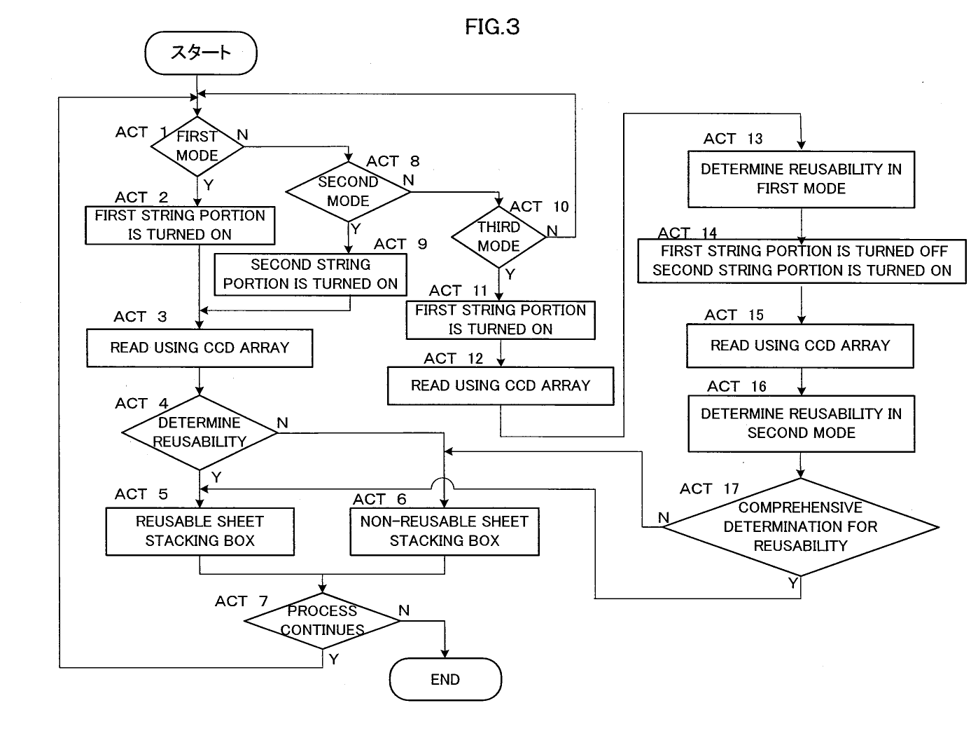

FIG. 1 is the overall configuration diagram illustrating an erasing device having a printing sheet reusability determination device according to an embodiment; FIG. 2 is a diagram illustrating a structure and a control block of a reusability determination portion according to a first embodiment provided in the erasing device in FIG. 1; and FIG. 3 is a flowchart illustrating an operation in the control block in FIG. 2.

An erasing device 1 shown in FIG. 1 has an endless sheet re-carrying path 3 in the upper part of a case 2, and a first reading portion 4, a second reading portion 5, and a printing image erasing portion 6 are sequentially disposed from the upstream side to the downstream side in the carrying direction in a lower horizontal carrying portion 3a.

The printing image erasing portion 6 includes a pair of upper and lower heating rollers 6a and 6b, and an erasable image is erased when a non-erased sheet passes through a nip portion between a pair of heating roller 6a and 6b. In this embodiment, erasable images on both sides of the non-erased sheet are simultaneously erased.

A bypass tray 7 which stacks therein a sheet on which an erasable image is printed (hereinafter, referred to as a “non-erased sheet”) is provided in the front side of the case 2. The front end of the bypass tray 7 is disposed at the upstream side of the horizontal carrying portion 3a, and a non-erased sheet stacked in the bypass tray 7 is intermittently fed to a pair of pre-carrying rollers 8a shown in FIG. 2 by a pair of paper feeding rollers (not shown). In addition, the bypass tray 7 is provided with a sheet detection sensor 7a and transmits a signal indicating whether or not a sheet is present to an instruction portion 14 shown in FIG. 2. If a signal indicating that a sheet is present is output from the sheet detection sensor 7a, for example, consecutive erasing is performed.

A pair of post-carrying rollers 8b which receives a sheet carried by the pre-carrying rollers 8a is disposed between the second reading portion 5 and the printing image erasing portion 6 as shown in FIG. 2. Further, the sheet is carried to the heating roller pair 6a and 6b of the printing image erasing portion 6 by the post-carrying rollers 8b.

In addition, a flapper 13 which changes carrying directions is disposed so as to face to the carrying end of the horizontal carrying portion 3a. Due to the changing by the flapper 13, a sheet (referred to as an “undetermined sheet”) which does not undergo a reusability determination, described later, of the erased sheets is carried towards the sheet re-carrying path 3, and a sheet (referred to as a “determined sheet”) which undergoes the reusability determination of the erased sheets is carried towards a sheet carrying portion 10 described later.

For the undetermined sheet re-carried by the sheet re-carrying path 3, both the front and rear sides thereof are read by the first reading portion 4 and the second reading portion 5 at the same time.

In this embodiment, the first reading portion 4 and the second reading portion 5 independently perform the detection of residual images on the erased sheet and the detection of appearance defects on the erased sheet by making irradiation states, such as the irradiation angles of illumination light which is applied to a sheet, be different. For this reason, for example, after the detection of residual images is completed, the appearance defects on the erased sheet are detected by changing the irradiation angle of the illumination light while passing through the sheet carrying portion 10 again. In addition, whether or not to reuse the erased sheet is determined based on the detection result of residual images on the erased sheet and the detection result of the appearance defects on the erased sheet.

In this embodiment, the first reading portion 4 reads a front surface which is a first surface of the erased sheet, and the second reading portion 5 reads a rear surface which is a second surface of the erased sheet along with the first surface.

Next, a sheet stacking portion 9 which stacks determined sheets of the erased sheets thereon is disposed under the sheet re-carrying path 3. In this embodiment, the sheet stacking portion 9 includes cassette installation portions in which a plurality of sheet cassettes 9a, 9b and 9c are arranged longitudinally, and the respective sheet cassettes are respectively extracted from an upper cassette installation portion, a middle cassette installation portion, and a lower cassette installation portion.

The sheet cassettes 9a, 9b and 9c are provided with IC chips 122. In the cassette installation portions, an upper transmission and reception portion 68A, a middle transmission and reception portion 68B, and a lower transmission and reception portion 68C which can perform transmission and reception with the IC chips 122 of the sheet cassettes 9a, 9b and 9c in a noncontact manner are disposed.

The uppermost first sheet cassette 9a contains thereon determined sheets of, for example, A3 size, which are determined as being reusable, and the middle second sheet cassette 9b contains thereon determined sheets of, for example, A4 size, which are determined as being reusable. The lowermost third sheet cassette 9c contains thereon determined sheets of free sizes, which are determined as not being reusable.

The sheet carrying portion 10, which carries determined sheets in the longitudinal direction, corresponding to the sheet stacking portion 9, is disposed inside the case 2. The sheet carrying portion 10 is provided with a first branch carrying portion 10a corresponding to the first sheet cassette 9a, and a second branch carrying portion 10b corresponding to the second sheet cassette 9b, and the carrying end of the sheet carrying portion 10 corresponds to the third sheet cassette 9c. In addition, a pair of paper feeding rollers 11 is disposed at each of the carrying ends of the first branch carrying portion 10a, the second branch carrying portion 10b, and the sheet carrying portion 10.

In addition, the sheet carrying portion 10 is provided with sorting devices 12a and 12b corresponding to the first branch carrying portion 10a and the second branch carrying portion 10b. When the determined sheet moving along the sheet carrying portion 10 reaches a corresponding sorting device, the corresponding sorting device blocks the carrying path of the sheet carrying portion 10, and forwards the determined sheet to the branch carrying portion. Thereby, the determined sheet is fed to a corresponding sheet cassette and contained thereon by the paper feeding roller pair 11.

In this embodiment, the determined sheets determined as being reusable are contained in the sheet cassettes of corresponding sizes by the driving of the first sorting device 12a and the second sorting device 12b. The determined sheet determined as not being reusable is carried from the carrying end of the sheet carrying portion 10 to the third sheet cassette 9c without the driving of the sorting devices 12a and 12b.

The case 2 is provided with a display screen and the instruction portion 14 including operation switches, a control portion (main CPU), a reusability determination portion, and the like on its upper surface.

The reusability determination portion will be described in detail with reference to FIGS. 2 and 3.

The first reading portion 4 and the second reading portion 5 have the same structure, and accordingly the same members are given the same reference numerals. In addition, the description of the first reading portion 4 will be made, and the description of the second reading portion 5 will be omitted.

In the first reading portion 4, an illumination portion 41 which illuminates a surface of a sheet S and a reference roller 42 which limits a reading position of the sheet S when the surface of the sheet S is read are disposed with a sheet carrying surface L interposed therebetween, and the illumination portion 41 irradiates the surface of the sheet S with illumination light. The light reflected from the surface of the sheet S forms an image on a CCD array 44 which is an imaging portion arranged in the main scanning direction, by an image forming lens 43.

The illumination portion 41 has a configuration in which a line of LED string 51 where a plurality of LEDs (Light Emitting Diodes) 51a is arranged in the main scanning direction is arranged on a base member 53 in plurality in the longitudinal direction, and the illumination light is disposed to be tilted with respect to the sheet carrying surface L. A LED group 52 in which the LED strings 51 are arranged in plurality in the longitudinal direction is vertically divided into a first string portion 52a including a plurality of LED strings 51 and a second string portion 52b including a plurality of LED strings 51. The irradiation angle θ1 of the illumination light from the upper first string portion 52a differs from the irradiation angle θ2 of the illumination light from the lower second string portion 52b.

The irradiation angle θ1 of the first string portion 52a is set to, for example, 45 degrees, and the irradiation angle θ2 of the second string portion 52b is set to an angle smaller than 45 degrees, thereby illuminating the surface of the sheet S so as to be parallel to the surface of the sheet S if possible. If wrinkles occur in the surface of the sheet S, the wrinkles generate parts which slightly protrude from the surface of the sheet S, thus when the first string portion 52a is turned off and the second string portion 52b is turned on, the irradiation light with the low angle from the second string portion 52b reaches the wrinkles, thereby forming shaded portions on the surface of the sheet S. The lower the irradiation angle of the irradiation light from the second string portion 52b is, the longer the shaded portions are, and thus the shaded parts can be more clearly recognized using the CCD array 44.

In addition, if the illumination light from the first string portion 52a is applied to the surface of the sheet S so as to be perpendicular thereto if possible, the surface of the sheet S is illuminated with high luminance, and residual images on the surface can be imaged by the CCD array 44 with high accuracy. However, the illumination light interferes with the light path of the reflected light from the sheet S, and thus the irradiation angle is set to 45 degrees as an example. However, the illumination portion 41 may be disposed with high angle to a degree that does not result in interference with the light path.

In other words, a lighting switching portion 61 switches turned-on states of the first string portion 52a and the second string portion 52b such that, when residual images are detected from the surface of the sheet S, the first string portion 52a of the LED group 52 is turned on, and when appearance defects on the erased sheet is detected, the second string portion 52b is turned on.

The instruction portion 14 has a selection portion which selects a first mode in which residues after erasure are detected, a second mode in which appearance defects on the erased sheet are detected, and a third mode in which residues after erasure and appearance defects are detected, and transmits selection mode information to a main CPU 66. The main CPU 66 performs operations for the entire erasing device by a program stored in a ROM of a memory portion 67. In addition, a RAM of the memory portion 67 stores cassette information described later which is transmitted to the IC chips 122 of the sheet cassettes, and transmits the cassette information to the corresponding IC chips 122 of the sheet cassettes in a noncontact manner via the upper transmission portion 68A, the middle transmission portion 68B, and the lower transmission portion 68C. In addition, a display screen of the instruction portion 14 displays the transmitted cassette information.

In addition, the main CPU 66 instructs the lighting switching portion 61 to switch to a turned-on state of the first string portion 52a and to a turned-on state of the second string portion 52b, and transmits the selection mode information to a sheet carrying control portion 62 which controls sheet carrying. The sheet carrying control portion 62 controls the driving of the flapper 13 and the paper feeding rollers according to the selection modes.

Information read by the CCD array 44 is transmitted to a reusability determination portion 63. Information for a detection mode is transmitted from the instruction portion 14 to the main CPU 66, and the reusability determination portion 63 determines reusability according to the transmitted mode. In the residues-after-erasure detection which is the first mode, reusability is determined based on image information such as, for example, a size or a density of residual images after erasure. In addition, in the second mode, reusability is determined based on image information such as the size or the density of shaded portions caused by wrinkles or folded end parts. Further, in the third mode, for example, if the detection results in both of the first and second modes show reusability, reusability is determined.

The CCD array 44 can detect the length of the sheet S to be read in the main scanning direction, and can detect the length in the carrying detection based on detection of positions of both ends of the sheet S in the carrying direction. A sheet size determination portion 64 determines the size of the sheet S to be read based on the information from the CCD array 44, and transmits the determination result to the sheet carrying control portion 62. In addition, the sheet size determination portion 64 counts the number of sheets for each size of the sheet based on information regarding the determination for the sheet S size.

The sheet carrying control portion 62 drives sheet carrying devices 65 such as the flapper 13, the first sorting device 12a, and the second sorting device 12b based on the sheet size and reusability determination result. By driving the sheet carrying devices 65, sheets determined as being reusable are contained in the first sheet cassette 9a and the second sheet cassette 9b of corresponding sizes.

In addition, sheets determined as not being reusable are contained in the third sheet cassette 9c. In addition, sheets for which reusability determination is not completed are carried along the sheet re-carrying path 3.

As such, in this embodiment, after an erasable image is erased from a sheet on which the erasable image is printed, the reusability determination can be automatically performed, and reusable sheets can be sorted and contained in a sheet cassette for each size. In addition, in the determination of the presence or absence of residues after the erasure and the determination of the presence or absence of wrinkles or folded parts or the like, the irradiation angles of illumination light applied to the sheet surface are made to be different, whereby illumination angles are lowered such that shaded portions caused by the wrinkles become long, and therefore it is possible to determine whether or not the wrinkles are present with high accuracy.

Operations of the reusability determination process for the erased sheet and the sorting process for the determined sheet will be described with reference to FIG. 3.

If the operation in this process starts, it is determined whether or not the instruction portion 14 selects the first mode for detecting residues after erasure (ACT 1). If the first mode is selected, the first string portion 52a of the LED group 52 is turned on in ACT 2, and illuminates the sheet S at an irradiation angle which is as close as possible directly thereabove. A light reflected from the sheet S is read by the CCD array 44 (ACT 3), and reusability determination for an erased sheet is performed (ACT 4).

In ACT 4, if the erased sheet is determined as being reusable (Y), the determined sheet is forwarded to the sheet carrying portion 10 side by driving the flapper 13, and the first and second sheet cassettes 9a and 9b of corresponding sizes contain the determined sheets by driving the sorting devices 12a and 12b of corresponding sheet sizes (ACT 5).

In ACT 4, if the erased sheet is determined as not being reusable (N), the determined sheet is forwarded to the sheet carrying portion 10 side by driving the flapper 13, and the determined sheet is contained in the third sheet cassette 9c without driving the sorting devices 12a and 12b (ACT 6). After the determined sheet is contained in the sheet cassette, if this process is continuously performed, the flow returns to ACT 1. In addition, if the reusability determination is consecutively performed for a plurality of erased sheets, the flow goes to ACT 3. If the process does not continue (N), the process is finished.

If the first mode is not selected in ACT 1 (N), it is determined whether or not the second mode for detecting wrinkles or the like is selected in ACT 8. If the second mode is selected (Y), the second string portion 52b of the LED group 52 is turned on, and illuminates the sheet S at as small an irradiation angle as possible, and the flow goes to ACT 3. In this case, the sheets S with no wrinkles or the like are contained in the first and second sheet cassettes 9a and 9b in ACT 5, and the sheets S with wrinkles or the like are contained in the third sheet cassette 9c.

If the second mode is not selected in ACT 1, it is determined whether or not the third mode for performing both the first and second modes in ACT 10 is selected, and if the third mode is not selected (N), the flow returns to ACT 1. In addition, if the third mode is selected (Y), the flow goes to ACT 11, ACT 12, and ACT 13, and the same processes as in ACT 2, ACT 3, and ACT 4 are performed. The determination result in ACT 13 is temporarily stored, and the flow goes to ACT 14.

In ACT 14, the first string portion 52a of the LED group 52 is turned off, the second string portion 52b is turned on, and the flow goes to ACT 15 and ACT 16 where the same processes as in ACT 2, ACT 3, and ACT 4 are performed. The determination result in ACT 16 is temporarily stored, and the flow goes to ACT 17.

In ACT 17, a comprehensive determination is performed based on the determination results in the first and second modes stored in ACT 13 and ACT 16. In the comprehensive determination in ACT 17, if the determination results in the first and second modes stored in ACT 13 and ACT 16 indicate the reusability of sheets (Y), the flow goes to ACT 5, and if all or either of the determination results indicate the non-reusability of sheets (N), the flow goes to ACT 6.

In addition, if the reusability determination is consecutively performed for a plurality of erased sheets in ACT 8 and ACT 10, the flow goes from ACT 7 to ACT 3 and ACT 12.

In this embodiment, both sides of the sheet S are simultaneously read by the first reading portion 4 and the second reading portion 5, but a single side of the sheet S may be read by either of the reading portions.

In addition, if the reusability determination is performed only in the first mode, the change of the irradiation angle is not required. In addition, the printing image erasing portion 6 is disposed downstream of the reading portions 4 and 5, but may be disposed reversely.

In addition, a carrying path for reversing a sheet is provided between the sheet carrying portion 10 and the sheet re-carrying path 3, the first surface of the sheet S is read, and then the sheet S is temporarily carried to the sheet carrying portion 10. The sheet on the sheet carrying portion 10 is carried to the sheet re-carrying path 3 via the carrying path for reversing a sheet, and then the second surface of the sheet S can be read by the reading portion.

In addition, the number of the determined sheets carried to each of the sheet cassettes 9a, 9b and 9c is counted, and thereby a warning may be emitted before reaching the number of sheets at which each sheet cassette is full.

In this embodiment, the first sheet cassette 9a, the second sheet cassette 9b, and the third sheet cassette 9c are common cassettes 110 each of which can be detachably installed at a paper feeding cassette portion 92, for example, in a multi function peripheral (MFP) 90, and can be exchanged with each other.

The MFP 90 may be of a type having an image forming portion which performs an image forming process using an erasable colorant of which a color disappears due to a chemical reaction when heated at a predetermined temperature or more, of a type of performing a normal image process using a non-erasable color material, or may be of both types.

The image forming apparatus 90 includes a paper feeding cassette portion 92 which sets sheets and forwards the sheets to a fixing portion 91 which heats and presses the sheets for fixing, a paper discharging portion 93 which discharges a sheet on which an image is formed, an operation portion 94 from which a user selects functions, a display portion 95 which displays selected functions or processed states, and an automatic document feeder (ADF) 97 which carries documents to be copied one by one to a scanner 96, and the scanner portion 96 obtains an image of an original document. The paper feeding cassette portion 92 includes first to fourth transmission and reception portions 130A, 130B, 130C and 130D which are installed in the respective cassette installation portions and transmit and receive data to and from the IC chip 122 provided in the inner wall of the installed common cassette 110. The first to fourth transmission and reception portions 130A, 130B, 130C and 130D are connected to the main CPU 131 which controls the entire image forming apparatus 90.

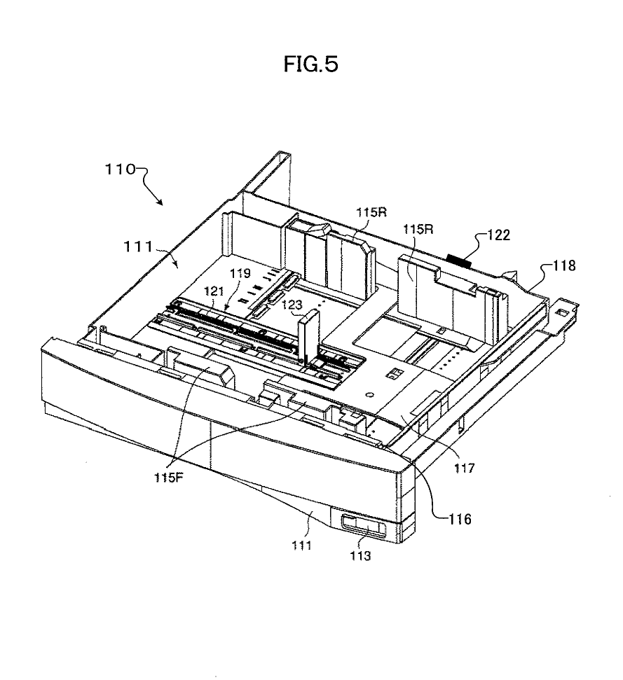

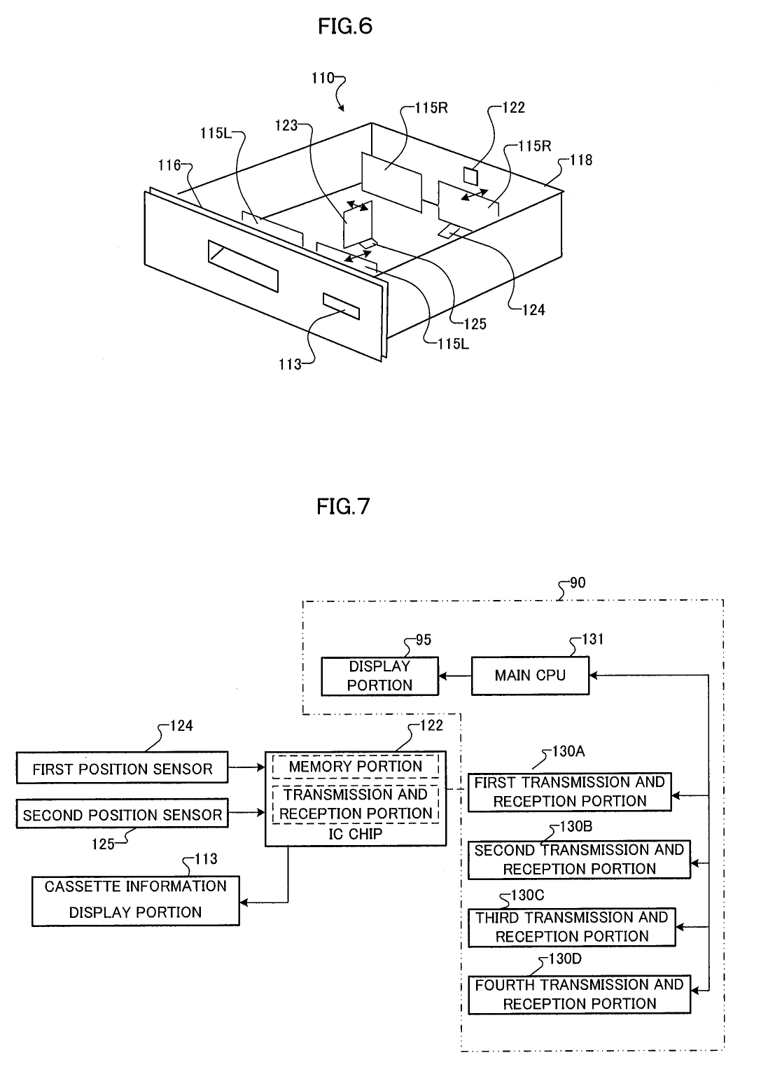

FIGS. 5 and 6 show the common cassette 110 which can be installed in the paper feeding cassette portion 92. The common cassette 110 has a cassette body 111 with a case structure containing sheets, and a cassette information display portion 113 which is disposed at a predetermined position of the cassette body 111, for example, in the bottom right part of the front side in FIG. 5 and which displays cassette information regarding sheets contained therein. The cassette information display portion 113 displays cassette information such as whether or not the contained sheets are the above-described erased sheets, the size of the contained sheets, and the number of remaining sheets contained therein, by, for example, a liquid crystal display or an LED lighting. Alternatively, only the size may be displayed by printing or the like. The plural pieces of cassette information are displayed based on data stored in the IC chips 122. In addition, a power source for driving the cassette information display portion 113 may be, for example, an internal battery, external power supply via a power supply terminal, or the like.

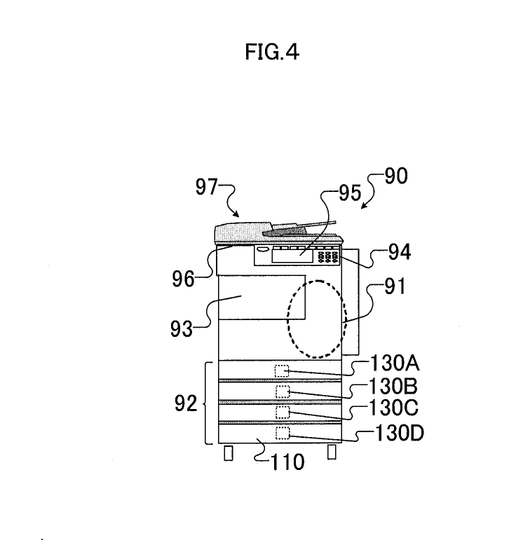

In a state where the common cassette 110 is installed in the erasing device 1 shown in FIG. 1, an erased sheet which is carried along the sheet carrying portion 10 is supplied from the right part of FIG. 4 by the paper roller pair 11 and then is stacked in the cassette body 111. In addition, in a state where the cassette 110 is installed in the MFP 90 shown in FIG. 4, an erased sheet can be extracted from the right part of FIG. 4 by pickup rollers (not shown).

When the direction perpendicular to the extraction direction of a sheet is the width direction in the cassette 110, a front side limitation member 115F and an inside limitation member 115R capable of being positioned are provided between a front side wall 116 and an inside wall 118 of the cassette body 111 so as to limit the position of a sheet in the width direction.

The limitation members 115F and 115R, although not described in detail, can be moved by a rack gear and a pinion gear by, for example, a pitch of 0.5 mm, and limit the position of a sheet in the cassette body 111, and the movement of the one moves the other.

In addition, in the sheet maintaining space defined by the limitation members 115F and 115R, in order to reliably extract a sheet using the pickup rollers, a pressing plate 117 which pushes up all of the sheets towards the pickup rollers from the lower side (bottom) of the cassette body 111 is provided.

A rear end limitation attachment 119 for limiting a position of a rear end of a sheet is provided in the cassette body 111. The rear end limitation attachment 119 can adjust a fixed position of an adjuster 123 according to the scale of a size indicating plate 121.

In other words, the size of a contained sheet is set by the positions of the limitation members 115F and 115R and the position of the adjuster 123. For this reason, as shown in FIG. 6, a first position sensor 124 which detects the positions of the limitation members 115F and 115R and a second position sensor 125 which detects the position of the adjuster 123 are provided in the cassette body 111.

The IC chip 122, which is installed in the inside wall of the cassette body 111, performs transmission and reception in a noncontact manner with the transmission and reception portions which are respectively provided in the erasing device 1 and the MFP 90, so as to rewrite data stored in the internal memory. The IC chip 122 stores cassette information such as its ID number, sheet size data detected by the sheet size sensor, and the number of contained sheets detected by the erasing device 1.

FIG. 7 shows a control block diagram in a state where the common cassette 110 is installed in the cassette installation portion of the image forming apparatus 90.

In FIG. 7, a state where the common cassette 110 is installed in the first stage cassette installation portion of the cassette installation portion is shown, and the transmission and reception portion of the IC chip 122 of the common cassette 110 performs transmission and reception with the first transmission and reception portion 130A which is installed in the first cassette installation portion of the image forming apparatus. The cassette information stored in the memory portion of the IC chip 122 of the common cassette 110 is received by the first transmission and reception portion 130A, and the main CPU 131 of the image forming apparatus 90 displays the cassette information of the common cassette 110 on the display portion 95. The displayed content may include, for example, a part where the common cassette 110 is installed (the first stage cassette installation portion in FIG. 7), whether or not the contained sheets are erased sheets, the sizes of the erased sheet contained, the number of the erased sheet contained, and the like.

A user of the image forming apparatus 90 can select whether or not to use the erased sheets on the display portion 95 when selecting sheets for printing images. In addition, if the sheets contained in the common cassette 110 are used, the main CPU counts the number of remaining sheets from the number of the erased sheets used, data for the number of the remaining sheets is transmitted to the IC chip 122 from the first transmission and reception portion 130A, and the IC chip 122 stores the number of remaining sheets in the memory portion. If the common cassette 110 is installed in the erasing device 1, the IC chip 122 transmits the number of the remaining sheets to the main CPU 66 of the erasing device 1, and the erased sheets can be supplied until the number of the erased sheets stacked reaches the maximum in consideration of the number of the remaining sheets.

### Second Embodiment

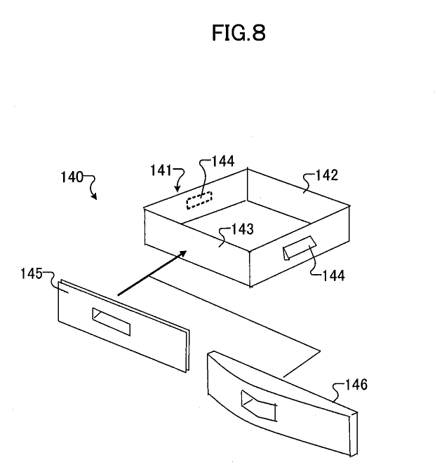

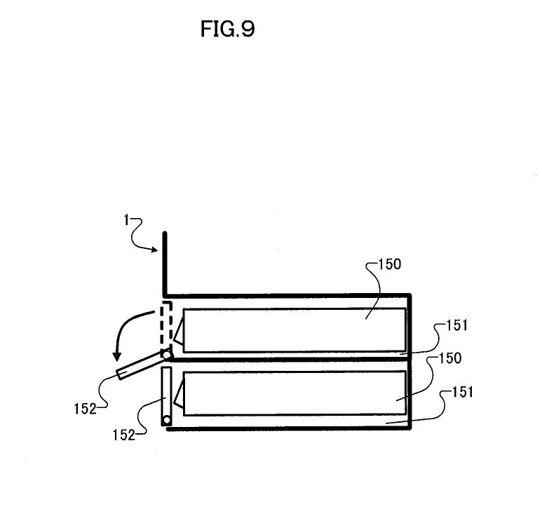

FIG. 8 is a schematic diagram illustrating a common cassette according to a second embodiment.

A common cassette 140 shown in FIG. 8 has a configuration in which a first front cover 145 for the erasing device and a second front cover 146 for the image forming apparatus which are provided in a front surface of a cassette body 141 are installed in the cassette body 141 which stacks and contains sheets, so as to be exchanged.

The first front cover 145 and the second front cover 146 have different shapes, and, for example, the first front cover 145 has a plate shape and the second front cover 146 has a convex shape.

The common cassette 140 on which the first front cover 145 is mounted can stack erased sheets in the erasing device. When the common cassette 140 detached from the erasing device is installed in the image forming apparatus, the first front cover 145 is detached and the second front cover 146 is installed. For this reason, the front side of the cassette containing portion of the image forming apparatus is unified with the design of the second front cover 146. In the same manner, the front side of the cassette stacking portion of the erasing device is unified with the design of the first front cover 145.

By providing grippers 144 at both the left and right sides of the cassette body 141, it is possible to easily handle the common cassette 140. In addition, the grippers 144 may be provided at other positions.

### Third Embodiment

FIG. 9 is a schematic diagram illustrating a common cassette according to a third embodiment.

In FIG. 9, front door portions 152 are installed in the front surface of a plurality of upper and lower cassette installation portions 151 which constitute a sheet stacking portion of the erasing device 1, so as to be opened and closed. Inside the cassette installation portion 151, sheet cassettes 150 in which the second front cover 146, for example, shown in FIG. 8 is fixed to the cassette body 141 are provided.

Therefore, the front surface of the cassette containing portion of the image forming apparatus is unified with the design of the second front cover 146. In the same manner, the front surface of the cassette stacking portion of the erasing device is unified with the design of the front door portion 152.

In addition, the second and third embodiments can be applied to the sheet cassette according to the first embodiment.

The processes in the first embodiment may be performed by the main CPU for processing internal data executing a program stored in advance in a storage region provided in the erasing device 1 or the MFP 90. In addition, the program may be downloaded to the main CPU from a network, or the program stored in a computer readable recording medium may be installed in the CPU. The recording medium will be sufficient as long as it stores a program and is readable by a computer. The recording medium may use, for example, a RAM (Random Access Memory), a ROM (Read Only Memory), a DRAM, an SRAM (Static Random Access Memory), a VRAM (Video RAM), or a flash memory.

The invention may have various forms without departing from the spirit or main features thereof. Thus, the above-described embodiments are only examples in all aspects and the invention is not limited to the disclosed embodiments. The scope of the invention is disclosed in the accompanying claims and thus is not restricted by the specification. Further, the accompanying claims and their equivalents are intended to cover various modification, various improvements, alternatives, and changes, which all fall within the scope of the invention.

What is claimed is:

1. An erasing device comprising:
an image erasing portion that erases an erasable image which is printed on a sheet using an erasable color material;
a reusability determination portion that determines whether or not to reuse the sheet obtained by erasing the erasable image by the image erasing portion;
a sorting carrying portion that carries the determined sheets to a carrying destination for reusable sheets and a carrying destination for non-reusable sheets according to the determination result from the reusability determination portion;
a common sheet cassette that can be used in an image forming apparatus and detachably installed in the carrying destination for reusable sheets, and that stacks and contains the sheets from the sorting carrying portion therein;
a storage medium that is installed in the common sheet cassette; and
a communication portion that stores information regarding the sheets contained in the common sheet cassette in the storage medium.

2. The device according to claim 1, further comprising a sheet size detection portion that detects sizes of the sheets,
wherein the carrying destination for reusable sheets is provided according to sheet sizes.

3. The device according to claim 1, wherein the common sheet cassette is disposed in the carrying destination for non-reusable sheets.

4. The device according to claim 2, wherein the storage medium stores sheet sizes detected by the sheet size detection portion.

5. The device according to claim 1, further comprising a counter that counts the number of sheets contained in the common sheet cassette,
wherein the storage medium stores the number of sheets counted by the counter.

6. The device according to claim 1, wherein the storage medium is an IC chip which can communicate in a noncontact manner.

7. The device according to claim 1, further comprising a cassette information display portion that is provided in a front surface of the common sheet cassette and displays information stored in the storage medium.

8. The device according to claim 1, wherein a front panel disposed in a front surface of the common sheet cassette can be exchanged for a front panel of a sheet cassette for the image forming apparatus.

9. The device according to claim 1, further comprising a front door portion that can open and close a front surface of an installation portion in which the common sheet cassette is installed,
wherein a sheet cassette body obtained by detaching a front panel of a sheet cassette for the image forming apparatus therefrom is installed in the installation portion.

10. An image forming apparatus comprising:
an image forming portion that forms an image on a sheet using a color material based on image information;
a sheet cassette installation portion in which a sheet cassette which feeds the sheet to the image forming portion is installed;
a common cassette that contains therein a sheet obtained by erasing an erasable image by an erasing device, stores information regarding contained sheets in a storage medium, and can be commonly used with the erasing device;
a communication portion that extracts information stored in the storage medium through communication with the storage medium;
a display portion that displays the information regarding sheets extracted via the communication portion; and
a control unit that controls the communication portion and the display portion.

11. The device according to claim 10, wherein the communication portion is provided at each sheet cassette installation portion.

12. The device according to claim 10, wherein the control portion counts the number of sheets used in the common cassette and stores the number of remaining sheets in the storage medium via the communication portion.

13. A sheet cassette common use system comprising:
an erasing device that has a sheet cassette which contains therein a sheet obtained by erasing an erasable image and a storage medium which stores information regarding contained sheets and is provided in the sheet cassette;
an image forming apparatus in which the sheet cassette provided with the storage medium as a commonly used cassette can be installed and forms an image on a sheet which is fed from the common cassette, using a color material based on image information; and
an information communication portion that is provided in both of the erasing device and the image forming apparatus and exchanges sheet information regarding contained sheets via the storage medium of the common cassette.

14. The system according to claim 13, wherein the sheet information is information regarding sizes of the contained sheets.

15. The system according to claim 13, wherein the sheet information is information regarding the number of the contained sheets.

16. A sorting method of erase-processed sheets comprising:
determining by a reusability determination portion whether or not to reuse the sheet obtained by erasing the erasable image which is printed on a sheet using an erasable color material by the image erasing portion;
carrying the determined sheets by a sorting carrying portion to a carrying destination for reusable sheets and a carrying destination for non-reusable sheets according to the determination result from the reusability determination portion;
stacking and containing the sheets from the sorting carrying portion on a common sheet cassette that install a storage medium and that can be used in an image forming apparatus and can be detachably installed in the carrying destination for reusable sheets; and
storing information regarding the sheets contained in the common sheet cassette in the storage medium by a communication portion.

17. A sorting erase-processed sheets method according to claim 16, further comprising,
detecting sizes of the sheets by a sheet size detection portion; and
carrying the sheet to the carrying destination for reusable and detectable size sheets.

18. A sorting erase-processed sheets method according to claim 16, further comprising,
disposing the common sheet cassette in the carrying destination for non-reusable sheets.

19. A sorting erase-processed sheets method according to claim 17, further comprising,
storing sheet sizes detected by the sheet size detection portion in the storage medium.

20. A sorting erase-processed sheets method according to claim 16, further comprising,
counting the number of sheets contained in the common sheet cassette by a counter; and
storing the number of sheets counted by the counter in the storage medium.
